(19) United States
(12) Patent Application Publication
(10) Pub. No.: US 2016/0121708 A1
(43) Pub. Date: May 5, 2016

(54) HYBRID DRIVE ASSEMBLY

(71) Applicant: ZF FRIEDRICHSHAFEN AG, Friedrichshafen (DE)

(72) Inventors: Rayk GERSTEN, Friedrichshafen (DE); Philipp RECHENBACH, Markdorf (DE)

(21) Appl. No.: 14/895,009

(22) PCT Filed: May 12, 2014
(86) PCT No.: PCT/EP2014/059600

§ 371 Date: Dec. 1, 2015

(30) Foreign Application Priority Data
Jun. 17, 2013 (DE) 10 2013 211 225.4

(51) Int. Cl. B60K 6/50; F16H 37/04; B60K 6/40; F16H 57/04; B60K 6/365; B60K 6/48

(52) U.S. Cl. CPC B60K 6/50; B60K 6/365; B60K 6/48; B60K 6/40; F16H 57/043; F16H 57/0475; F16H 57/0423; F16H 37/046; F16H 57/0484; Y10S 903/91; B60Y 2410/00; B60Y 2400/73; B60Y 2304/00; B60Y 2200/10

(57) ABSTRACT

A hybrid drive assembly of a motor vehicle having a main transmission (2) with a transmission input shaft (4) and a transmission housing, an electric machine (5) which has a rotor (5b) and can be operated as a motor and as a generator and which is arranged on the input side relative to the main transmission (2) and a planetary gear system (6) which has a sun gear (7), a carrier (8) and a ring gear (9). The planetary gear system (6) is connected, on the one hand, by way of the sun gear (7) to the rotor (5) and, on the other hand, to the transmission input shaft (4, 24), in a rotationally fixed manner, via the carrier (8). The ring gear (9) is fixedly secured to the housing.

This application is a National Stage completion of PCT/EP2014/059600 filed May 12, 2014, which claims priority from German patent application serial no. 10 2013 211 225.4 filed Jun. 17, 2013.

### FIELD OF THE INVENTION

The invention concerns a hybrid drive assembly of a motor vehicle.

### BACKGROUND OF THE INVENTION

From DE 10 2008 000 953 A1 by the present applicant a parallel hybrid drive assembly for a vehicle is known, wherein a planetary gearset is connected between an electric machine and a main transmission. The three-part planetary gearset, which comprises a sun gear, a carrier or planetary carrier and a ring gear, serves mainly as a rotational direction reversal device for obtaining a reverse gear, since the main transmission does not have a reverse gear. In the planetary gearset, which is arranged on the transmission input side, the carrier or planetary carrier is fixed; the rotor of the electric machine is connected to the sun gear and the drive output ring gear is coupled to the transmission input shaft. Thus, the rotor drives the transmission input shaft by way of a fixed transmission ratio of the planetary gearset, so that a rotational direction reversal takes place.

### SUMMARY OF THE INVENTION

The purpose of the present invention, in a hybrid drive assembly of the type mentioned to begin with, is to achieve a further improvement of the drive behavior, in particular an adaptation of the electric machine to the rotational speed of the transmission input shaft.

The objective of the invention is achieved by the characteristics and advantageous design features as discussed below.

According to the invention, it is provided that the carrier of the planetary gearset is coupled to the transmission input shaft and the ring gear is held fixed. Thus, a fixed transmission ratio of the planetary gearset acts between the electric machine and the transmission input shaft. When the electric machine is working in motor mode, the rotational speed of the rotor is converted to slow speed by the fixed transmission ratio; during overdrive operation, when the electric machine is working as a generator, the rotational speed of the transmission input shaft is increased to high speed by the fixed transmission ratio. The fixed transmission ratio does not produce a rotational direction reversal.

According to a preferred embodiment the rotor is arranged on a rotor carrier, which is supported in the housing by a fixed bearing. Thus, the rotor is fixed relative to the housing in the radial and axial directions.

In a further preferred embodiment, the carrier of the planetary gearset has a cylindrical neck which is connected to the transmission input shaft in a rotationally fixed and non-pivoting manner. Preferably, the neck is connected rotationally fixed to the transmission input shaft by spline teeth in the form of a fixed seating and secured against pivoting by a centering seat. Thus, the carrier is connected virtually solidly to the transmission input shaft.

In a further preferred embodiment, the carrier—by way of the transmission input shaft—is mounted statically fixed, this being by virtue of a first bearing in the form of a fixed bearing preferably arranged on the housing of the main transmission and by a second bearing in the form of a loose bearing, a so-termed pilot bearing, in the area of the internal combustion engine.

According to a further preferred embodiment, the carrier is connected to a bolt carrier which is preferably supported relative to the rotor carrier by a needle bearing. Thus, the rotor carrier is mounted in two ways, namely on the one hand by the fixed bearing and on the other hand by the needle bearing.

In a further preferred embodiment, the rotor carrier is connected to the sun gear by spline teeth, wherein the inner teeth of the rotor carrier and the outer teeth of the sun gear can move axially relative to one another. Thus, the rotor carrier can be installed by pushing it into place in the axial direction.

In a further preferred embodiment, the sun gear has a cylindrical neck at the end of which the spline teeth are arranged and the torque can be transmitted.

According to a further preferred embodiment, the neck of the sun gear extends radially into the hub of the rotor carrier. This has the advantage of being a space-saving design: the planetary gearset can be fitted in a “fitting-space-neutral” way, i.e. without taking up additional space inside the rotor.

In a further preferred embodiment, the sun gear is integrated with the rotor carrier, i.e. the sun gear forms a structural unit with the rotor carrier, preferably with the hub of the rotor carrier. By virtue of this variant the above-mentioned needle bearing between the bolt carrier and the rotor hub, as well as the neck of the sun gear with spline teeth, can be omitted.

In a further preferred embodiment, the gearwheels of the planetary gearset have helical teeth. This results in less noise and quieter running.

According to a further preferred embodiment the oil supply system of the planetary gearset and the electric machine is connected to the oil supply system of the main transmission. For that purpose an oil transfer port and longitudinal and transverse bores are provided in the transmission input shaft, by way of which the lubricating and cooling oil is fed in and drained away.

In a further preferred embodiment, oil is returned from the oil space of the hybrid housing to the oil space of the main transmission via an oil return pipe, which runs between the two transmission housings. This ensures the lubrication and cooling of the planetary gearset, the bearings and the electric machine.

In a further preferred embodiment the ring gear is connected to the hybrid housing by a ring gear carrier. Preferably, the ring gear carrier engages with outer teeth in the inner teeth of the ring gear.

According to a further preferred embodiment, the electric machine is designed as a permanently energized synchronous machine. For reasons to do with power density the permanently energized synchronous machine is designed for a relatively high rotational speed, which is adapted to the lower rotational speed of the transmission input shaft by virtue of the fixed transmission ratio of the planetary gearset. This gives the advantage that an electric machine with relatively low weight, compact fitting volume and relatively low cost can be used for the hybrid drive.

### BRIEF DESCRIPTION OF THE DRAWINGS

Example embodiments of the invention are illustrated in the drawing and will be described in more detail below, so that from the description and/or the drawing further features and/or advantages can emerge. The drawings show:

FIG. 1: A schematic representation of the hybrid drive assembly according to the invention,

FIG. 2: A design embodiment of the hybrid drive assembly according to the invention,

FIG. 3: A schematic representation of a bearing arrangement for the hybrid drive assembly,

FIG. 4: A representation of the oil flows for supplying lubrication oil to the hybrid drive assembly,

FIG. 5: A design detail for an oil return, and

FIG. 6: A second embodiment of the hybrid drive assembly.

### DETAILED DESCRIPTION OF THE PREFERRED EMBODIMENTS

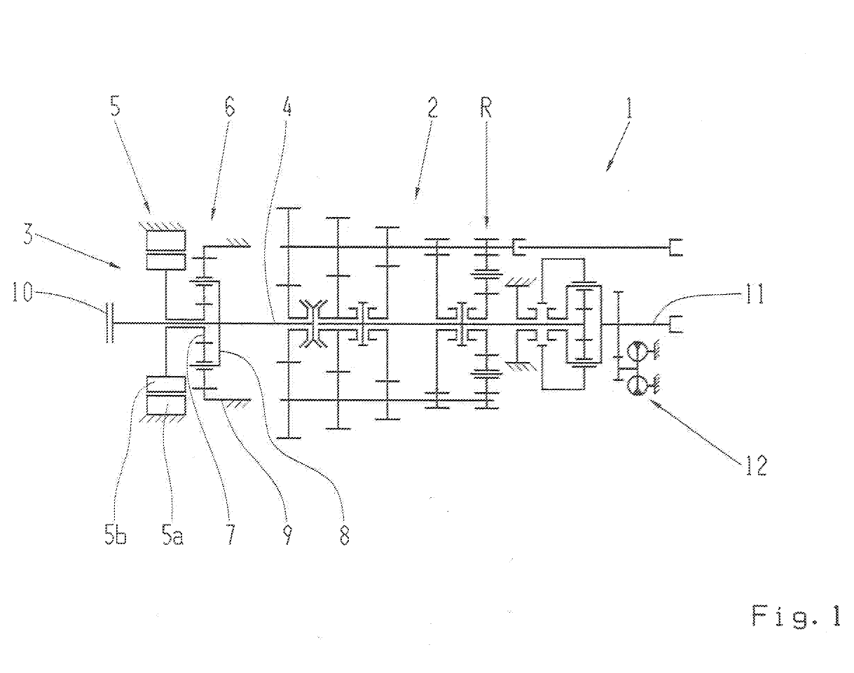

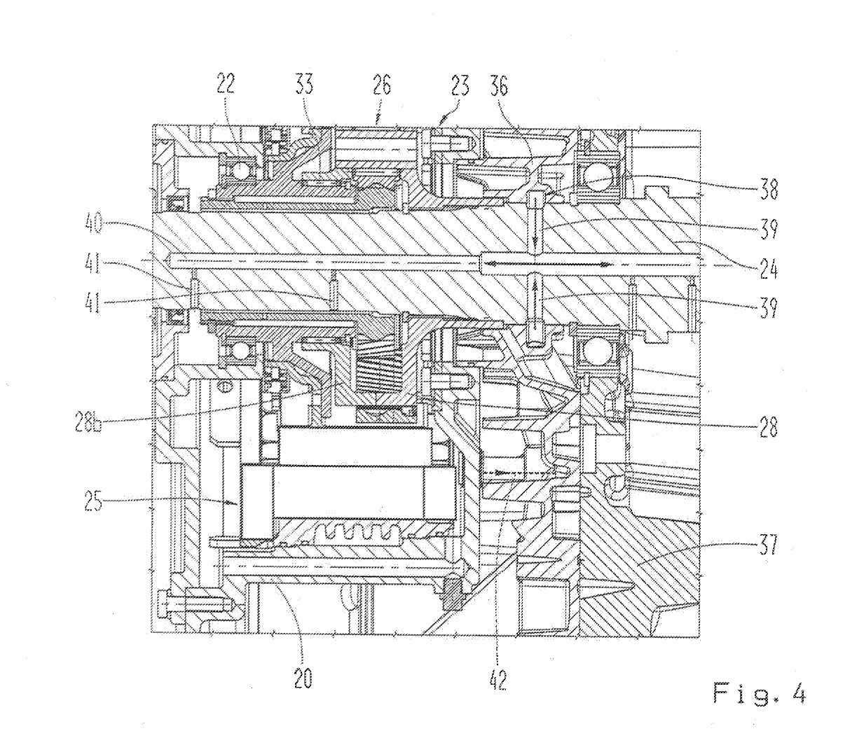

FIG. 1 shows a schematic representation of a hybrid drive assembly 1, which comprises a main transmission 2 and a hybrid module 3. The main transmission has a transmission input shaft 4, a number of gear steps (not indexed) for forward gears and one gear step for a reverse gear R. The hybrid module 3 comprises an electric machine 5 with a stator 5a and a rotor 5b, and also a planetary gearset 6 which is connected on the one hand to the rotor 5b and on the other hand to the transmission input shaft 4. The planetary gearset has three parts, namely a sun gear 7, a carrier or planetary carrier 8 and a ring gear 9, which is supported on the housing. Thus, a fixed transmission ratio of the planetary gearset 6 acts between the rotor 5b and the transmission input shaft 4. The transmission input shaft 4 is connected by a clutch 10 to an internal combustion engine (not shown) of a motor vehicle. The hybrid drive assembly 1 is thus a parallel hybrid. Further, the main transmission 2 has a transmission output shaft 11 which drives an oil pump 12 that supplies oil both to the main transmission 2 and to the hybrid module 5, as will be described in more detail with reference to FIG. 4. In a preferred embodiment the electric machine 5 is a commercially available, permanently energized synchronous machine and can be operated both as a motor and as a generator. The permanently energized synchronous machine (PSM) is preferably designed for a relatively high rotational speed in order to increase the power density and to reduce the use of costly materials. Thus, the planetary gearset 6 acts as a step-down stage between the higher rotational speed of the rotor 5b and the lower rotational speed of the transmission input shaft 4. The planetary gearset, i.e. the sun gear 7, the planetary gearwheels and the ring gear 8, have helical gearteeth.

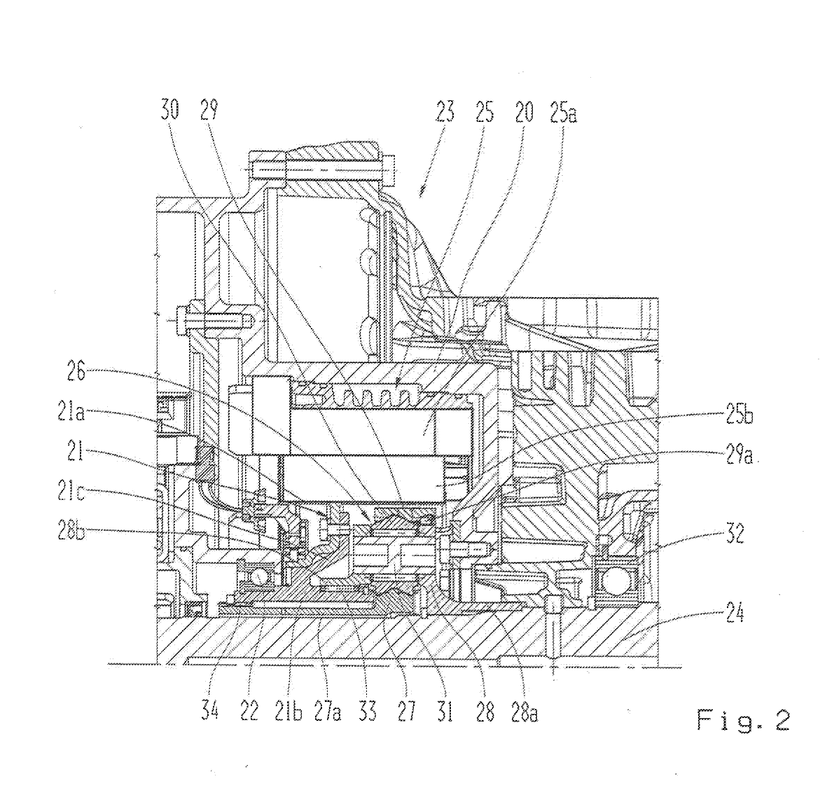

FIG. 2 shows a design embodiment of a hybrid module 23, as represented schematically as the hybrid module 3 in FIG. 1. In what follows, analogous components are given indexes increased by 20 compared with those in FIG. 1. An electric machine 25, which comprises a stator 25a and a rotor 25b, is arranged in a hybrid housing 20. The rotor 25b has a rotor carrier 21 mounted relative to the hybrid housing 20 by means of a fixed bearing in the form of a roller bearing 22. The rotor carrier 21 comprises a drum 21a arranged radially on the outside, a hub 21b arranged radially on the inside, and a supporting disk 21c that connects the drum 21a and the hub 21b. Radially inside the drum 21a and to the right of the supporting disk 21c in the drawing is arranged a planetary gearset 26 which—analogously to the schematic representation in FIG. 1—comprises a sun gear 27, a carrier 28, a ring gear 29 and planetary gearwheels 30. The carrier 28, also called the planetary carrier 28, has a neck 28a which is arranged in a rotationally fixed and non-pivoting manner on the transmission input shaft 24, which is done on the one hand by virtue of spline teeth as a fixed seating and on the other hand by a centering seat. On the side facing away from the carrier 28 is arranged a bolt carrier 28b, which is connected fixed to the carrier 28 (for this see also FIG. 4). The carrier 28 and the bolt carrier 28b carry planetary bolts 31 on which the planetary gearwheels 30 are mounted. The ring gear 29 is connected to the hybrid housing 20 by means of a ring gear carrier 29a which has outer teeth that engage with the inner teeth of the ring gear 29, i.e. the ring gear 29 is attached fixed to the housing. On the housing side the transmission input shaft 24 is supported by a fixed bearing 32. The bolt carrier 28b is supported relative to the hub 21b of the rotor carrier 21 by a needle bearing 33, i.e. a loose bearing. The sun gear has a neck 27a which is coaxial with the transmission input shaft 24 and is separated from the latter by an annular gap, which neck, in the area of the fixed bearing 22, is connected by axially movable spline teeth 34 to the rotor carrier 21 or its hub 21b.

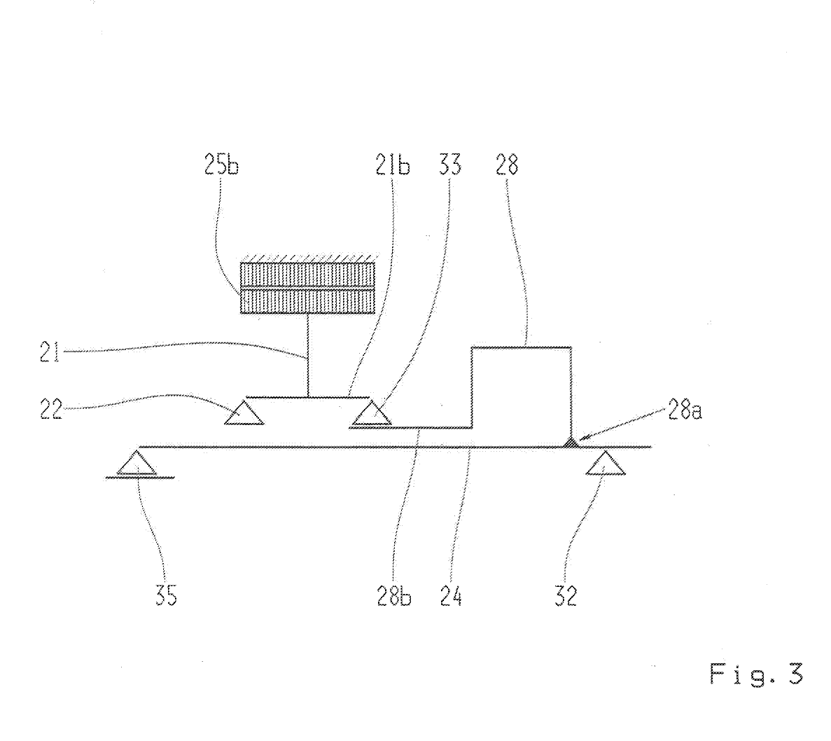

FIG. 3 shows a schematic representation of the bearing design of the hybrid module 23, as it is depicted in FIG. 2. In what follows, for the same or analogous components the same indexes are used as in FIG. 2. The rotor 25b is supported by the rotor carrier 21 and its hub 21b, by means of the fixed bearing 22 and the loose bearing in the form of a needle bearing 33. At the point 28a (which corresponds to the neck 28a) the carrier 28 is connected in a rotationally fixed and non-pivoting manner to the transmission input shaft 24. The latter is mounted by means of the fixed bearing 32 attached fixed to the housing and a pilot bearing 35 in the form of a loose bearing in the area of the internal combustion engine (not shown).

FIG. 4 shows a further section of the hybrid module 23—again, with the same indexes as in FIG. 2 used for the same components. The hybrid module 23 comprises a hybrid housing 20 in which, essentially, the electric machine 25, the planetary gearset 26 and the bearings 22, 33 are accommodated. The hybrid housing 20 is connected to the transmission housing 37 of the main transmission 2 by means of a connection plate 36. As regards its oil supply the hybrid module 23 is connected to the oil circuit of the main transmission 2 which—as shown in FIG. 1—has an oil pump 12 of its own. The lubrication and cooling oil, called just oil for short in what follows, is passed into the hybrid module 23 via a transfer port 38 in the connection plate 36, from where, by way of transverse ducts 39 in the transmission input shaft 24, it passes into a longitudinal duct 40. From the longitudinal duct 40 in the transmission input shaft 24, the oil flows outward via two further transverse ducts 41 and by way of two different oil flow paths supplies the lubrication and cooling points of the hybrid module 23. The oil returns to the main transmission 2 via a return path 42 shown by a broken line.

In the lower half of FIG. 4—as indicated above—it can also be seen that the carrier 28 and the bolt carrier 28b are mechanically connected to one another and form a structural unit.

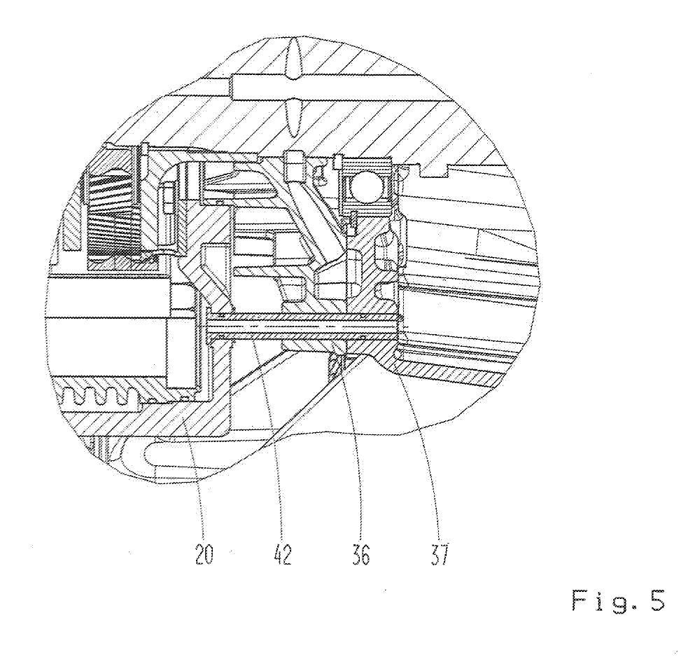

FIG. 5 shows the oil return path 42 in the form of a return pipe 42 that passes through the connection plate 36 and forms a flow connection between the oil space of the hybrid housing 20 and the oil space of the transmission housing 37.

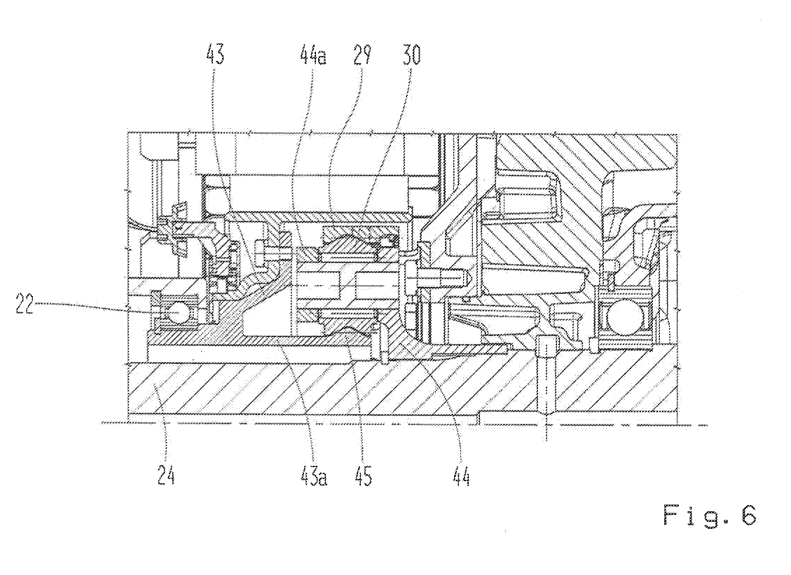

FIG. 6 shows a second example embodiment of the invention, with a modified rotor carrier 43 and a modified carrier 44. The second example embodiment differs from the first example embodiment in FIG. 2 in that no needle bearing 33 or support between the carrier and the rotor carrier is provided. Instead, the rotor carrier 43, which is supported on the housing side by the fixed bearing 22, has a cylindrical neck 43a arranged coaxially with the transmission input shaft 24, at the end of which a sun gear 45 is fixed. Thus, the sun gear 45 is integrated in the rotor carrier 43 or its neck 43a and forms a structural unit therewith. The sun gear 45, which has helical teeth, engages in the planetary gearwheel 30 which is engaged with the fixed ring gear 29. The bolt carrier 44a, which is connected fixed to the carrier 44, is modified by comparison with the embodiment according to FIG. 2 in that it has no bearing race for a bearing. Thus, the bolt carrier 44a is not supported on the rotor carrier 43 but instead, exclusively on the carrier 44 which—as in the example embodiment according to FIG. 2—is connected in a rotationally fixed and non-pivoting manner to the transmission input shaft 24.

### INDEXES

1 Hybrid drive assembly

2 Main transmission

3 Hybrid module

4 Transmission input shaft

5 Electric machine

5a Stator

5b Rotor

6 Planetary gearset

7 Sun gear

8 Carrier (planetary carrier)

9 Ring gear

10 Clutch

11 Transmission output shaft

12 Oil pump

20 Hybrid housing

21 Rotor carrier

21a Drum

21b Hub

21c Supporting disk

22 Fixed bearing

23 Hybrid module

24 Transmission input shaft

25 Electric machine

25a Stator

25b Rotor

26 Planetary gearset

27 Sun gear

27a Neck

28 Carrier

28a Neck

28b Bolt carrier

29 Ring gear 29a Ring gear carrier

30 Planetary gearwheel

31 Planetary bolt

32 Fixed bearing

33 Needle bearing

34 Spline teeth

35 Pilot bearing (loose bearing)

36 Connection plate

37 Transmission housing

38 Oil transfer port

39 Transverse duct

40 Longitudinal duct

41 Transverse duct

42 Oil return

43 Rotor carrier

43a Neck

44 Carrier

44a Bolt carrier

45 Sun gear

R Reverse gear

1-14. (canceled)

15. A hybrid drive assembly of a motor vehicle comprising:
a main transmission (2) with a transmission input shaft (4, 24) and a transmission housing (37),
an electric machine (5, 25) having a rotor (5b, 25b), the electric machine (5, 25) being operable as a motor and as a generator and the electric machine (5, 25) being arranged on an input side relative to the main transmission (2),
a planetary gear system (6, 26) comprising a sun gear (7, 27, 45), a carrier (8, 28, 44) and a ring gear (9, 29), the planetary gear system (6, 26) being connected so that the sun gear (7, 27, 45) being rotationally fixedly connected to the rotor (5b, 25b), the carrier (8, 28, 44) being rotationally fixedly connected to the transmission input shaft (4, 24) and the ring gear (9, 29) being fixedly connected to the housing.

16. The hybrid drive assembly according to claim 15, wherein the rotor (25b) is connected to a rotor carrier (21, 43) which is supported on the housing by a fixed bearing (22).

17. The hybrid drive assembly according to claim 15, wherein the carrier (28) has a cylindrical neck (28a) which is connected to the transmission input shaft (24) in a rotationally fixed and non-pivoting manner.

18. The hybrid drive assembly according to claim 15, wherein the carrier (28, 44) is statically fixedly mounted by a first bearing (32) and a second bearing (35).

19. The hybrid drive assembly according to claim 16, wherein the carrier (28) has a bolt carrier (28b) which is supportable on the rotor carrier (21, 21b).

20. The hybrid drive assembly according to claim 15, wherein the rotor carrier (21) is connected to the sun gear (27) by axially displaceable spline teeth (34).

21. The hybrid drive assembly according to claim 20, wherein the sun gear (27) has a cylindrical neck (27a) and the spline teeth (34) are arranged at an end of the cylindrical neck (27a) facing away from the sun gear (27).

22. The hybrid drive assembly according to claim 21, wherein the rotor carrier (21) has a hub (21b) and the cylindrical neck (27a) of the sun gear (27) is arranged radially inside the hub (21b).

23. The hybrid drive assembly according to claim 16, wherein the sun gear (45) is integrated in the rotor carrier (43) and is arranged on the side of the rotor carrier (43) facing away from the fixed bearing (22).

24. The hybrid drive assembly according to claim 15, wherein the planetary gear system has helical gearteeth.

25. The hybrid drive assembly according to claim 15, wherein the transmission input shaft (24) has a central oil bore (40) and transverse bores (39, 41) for supplying oil to the planetary gear system (26) and to the electric machine (25).

26. The hybrid drive assembly according to claim 15, wherein the planetary gear system (26) and the electric machine (25) are accommodated in a hybrid housing (20) and the hybrid housing (20) is connected to the transmission housing (37) of the main transmission (2) by an oil return pipe (42).

27. The hybrid drive assembly according to claim 26, wherein a ring gear carrier (29a) connects the ring gear (29) to the hybrid housing (20).

28. The hybrid drive assembly according to claim 15, wherein the electric machine is a permanently energized synchronous machine (25).

29. A hybrid drive assembly of a motor vehicle comprising:
a main transmission (2) with a transmission input shaft (4, 24) and a transmission housing (37),
an electric machine (5, 25), having a rotor (5b, 25b), and being operable as a motor and as a generator, and the electric machine (5, 25) being arranged on an input side relative to the main transmission (2),
a planetary gear system (6, 26) comprising a sun gear (7, 27, 45), a carrier (8, 28, 44) and a ring gear (9, 29), the planetary gear system (6, 26) being connected by way of the sun gear (7, 27, 45) to the rotor (5b, 25b), the carrier (8, 28, 44) being connected to the transmission input shaft (4, 24), and the ring gear (9, 29) being fixedly connected to the housing.
